(19) United States
(12) Patent Application Publication
(10) Pub. No.: US 2014/0156461 A1
(43) Pub. Date: Jun. 5, 2014

(54) Mobile Shopping System And Method

(71) Applicant: Maximilian Lerner, New York, NY (US)

(72) Inventor: Maximilian Lerner, New York, NY (US)

(21) Appl. No.: 14/034,276

(22) Filed: Sep. 23, 2013

Related U.S. Application Data
(60) Provisional application No. 61/704,099, filed on Sep. 21, 2012.

(51) Int. Cl. G06Q 30/06

(52) U.S. Cl. CPC G06Q 30/0623; G06Q 30/0635
USPC 705/26.61

(57) ABSTRACT

A mobile shopping system and method providing consumers the ability to scan a bar code or search of an item online and purchase the item. The item may be purchased in store or online which is then shipped to the consumer. The invention also serves a retailer in permitting the retailer to verify an in-store purchase or deter theft by weighing a product. The retailer may also keep track of inventory and monitor a consumer's purchasing habits. The invention further provides a retailer-consumer and consumer-consumer geo-locating and tracking map; a social shopping network using consumer mobile shopping profiles, as well as a rewards system.

### PRIORITY AND RELATED APPLICATION

This application claims priority to U.S. Provisional Patent Application Ser. No. 61/704,099, filed Sep. 21, 2012, entitled “BAR-CODE SCANNING AND INFORMATION-ACCESSING SYSTEMS,” which is hereby incorporated by reference in its entirety.

### FIELD OF THE INVENTION

The present invention relates to a mobile shopping system and method. The invention permits a purchaser to automate purchasing of products and provides the seller information about its sales and inventory.

### BACKGROUND OF THE INVENTION

Prior to the present invention consumers bought items at businesses and local retailers by waiting in a shopping line and paying at a checkout counter The entire shopping process was based on an individual's searching a store for consumables. Customer service was limited to retail associates directing consumers through the store, or helping when asked. The entire retail experience was alienating, discursive and often confusing.

Previously, the art related to improving and accelerating the in-store shopping and payment process was limited and cumbersome, operating on hand-held scanners, or mobile applications that compare and manage shopping lists for consumables such as groceries, office supplies, home accessories, gardening supplies, etc. Payment automation was limited to home delivery and checkout confirmation. Verification and security was in accordance with a consumer's profile: how often they bought groceries, how much they typically paid, along with other factors such as age, race, and socioeconomic background There was no way to digitize lists. track shopping progress or locate customers in the store. Searching for a specific consumable was time-consuming, and difficult, since retail associates are often limited in their ability to aid consumers according to supply and demand. Mobile scanning applications, especially, involved working with one specific retailer, sometimes limited to one specific store.

Many of the systems involved in accelerating the checkout process conflated different processes, such as price comparisons, shopping list management, discount notification, and payment recognition, without satisfactorily improving the consumer's wait time while shopping. Much of the prior art skirted the problem of time management while shopping, instead focusing on product suggestions, coupon codes, or the facilitation of home delivery. The prior art was inflexible, inadaptable and worked only in immediate and complete implementation. For many prior arts, this was acceptable in allowing the market to use it singly, or to focus on a specific retailer to work with. Moreover, while the prior art gave the user a new method for payment and waiting, it did not function as a stand alone product, distributed application, and networked solution; instead it solved only one of these important inseparable aspects, functioning in a specific and fragmented niche particular to one retailer, or one mobile software, or in one service. Those prior arts that did attempt more, often confused and dissuaded the consumer from continued use through interfacing, excessive features, commercial effort, or lack of positive benefits.

Instead of focusing equally on retailer and consumer, the prior art tended to focus solely on the consumer. From the retailer's perspective, these prior arts left every aspect of the shopping experience in the hands of the consumer, thus making them even more difficult to implement quickly and across broad channels. None of the prior art was attractive to both retailers and consumers, nor did it confront the underlying existing problem in the retail market; namely, that of how to improve the retail shopping experience.

Recently, consumers have started to use mobile applications to scan and learn about products while in-store, often comparing user reviews and prices regarding a specific product. For a longer time. consumers have been comfortable buying consumables online. None of the prior art, however, focused on wholly changing the retail process through an all-inclusive app that included shopping, social and map-based features. Much of the prior art targeted only one or two of these aspects, ineffectually changing the face of retail, instead facilitating smaller, more incremental processes, such as the finding of coupons, the virtual mapping of friends, or the scanning of a product to find out more about it. None of the prior art have had the general accessibility, efficiency, or social component of the present invention.

To introduce a new mobile shopping strategy is the goal of the present invention. The present invention intends to achieve this by allowing consumers to bypass lines, search for friends and consumables in-store, and communicate with retailers and friends within a virtual network, not necessarily relegated to the present invention's, in order to allow the consumer a crosschannel and open-platform mobile shopping experience. The present invention solves the problem of the checkout-line for consumers and facilitates inventory management for retailers. It allows consumers to track past and present purchases while shopping with friends and family within their social network. And it works to transform the shopping experience through a more interconnected approach, shifting the focus from the buying of consumables into the ease and satisfaction of tracking consumables and the monetary rewards and social benefits that come with using a mobile platform to base their shopping approach, transforming what has for many years been an errand into a pleasant experience.

The shortcomings in the prior art inventions result from their inability to understand the primary consumer problem; namely, that of inconvenience while shopping, as well as secondary problems which relate to the retailer and presentation of a mobile shopping application. These shortcomings include:

### Simplicity

Consumers want an application that they can use again and again. The prior art offers an overwhelming number of features and choices for the consumer, distracting from the primary goal of buying consumables in as easy a manner as possible. The prior art offers too many features at once, such as price comparisons, geo-location, discount notifications, and other gimmicks, without offering incentive for consumers to continue using the app instead of returning to their original shopping methods. Software limitations have also been an issue, forcing consumers to learn a new system in a technologically incipient realm. As a result, much of the prior art has been too complicated for consumers to want to use again. The prior art distracts consumers with peripheral features without offering the preferred evolutionary step in the mobile shopping industry toward a holistic mobile shopping approach.

Rewards: Prior art relied only on the newness of the instant checkout process to attract retailers and consumers. But consumers are reluctant to test a new technology without a clear reward system or special discount for using the new method. As a result, the prior art has been slow to catch on in the mobile shopping industry. Without a rewards system the prior art struggles to attract and retain customers, since there is no incentive for continued use. For retailers, prior art lacks the retail tools and information that make a third-party rewards system beneficial and worthwhile.

### Social Integration

The prior art works without a social aspect, thus reinforcing the anomie and alienation that many American consumers experience when entering a 150,000 square foot store with 30,000+ products on the shelves. There is no way to follow other users, link profiles or share accounts. Users cannot interact and share reviews, food information, photographs, chat directly with each other about their shopping experience, notify friends about out-of network deals, or about having completed a particular shopping task; and of any other social options consumers would desire when shopping alone. In short the prior art fails to provide what acts as a driving motivator for many consumers: fun.

### Standardization

Businesses want to implement a new system slowly and at minimal cost. The prior art ignores retailers for the sake of consumers, without determining how such a system could become standard in a larger operation both in terms of cost and convenience to retailers. The prior art is deficient because it provides insufficient attention to how retailers catalog and manage their inventory. Much of the prior art also fails to integrate a notification and reward system to notify retailers when preferred customers enter the store or location, lacking the high customer service so many customers desire. It also fails to integrate a detailed analytics system with a stock and aisle management system. Prior art fails to offer a seamless transfer to new technology, either moving from cashier checkout to mobile checkout directly or incompletely. The prior art also does not take into account the different possible methods by which an item can be bought—UPC codes. RFID tages, QR codes, or the adding of a price into a mobile app and touching the mobile device with another payment-compatible mobile device. Much of the prior art was designed to work on a single network, platform and channel, without taking into consideration the future and evolution of mobile shopping. Most of the prior art is for small or mid-size retailers and does not take into account larger retail options.

### Selection at Point of Purchase

Some prior art works to provide checkout at point of purchase, but fails to expedite how the consumer reaches that point of purchase. The prior art is limited to a specific mobile network or platform and often fails to work within a certain range. By using geo-location to map retailer's stores, the present invention optimizes the consumer's shopping experience by syncing lists with an in-store path designed to draw the consumer as quickly as possible through the store without having to backtrack, while tracking lists for most bought or highest rated consumables, even taking into account which items are most prone to spoil based on ambient temperature.

### Privacy

Consumers enjoy a certain sense of privacy and customization in their preferences. The prior art works with a specific store and a third party retailer in organizing and sorting payment information, usually through user and password data. Consumers prefer the freedom and privacy of mobile applications to work universally, with the option of paying by cash, credit or debit card, or through a third-party holding system. In order to customize preferences and secure payment for specific retail items, the prior art profiles consumers according to past receipts. The result takes liberties in exploiting users' privacy. None of the prior art keeps consumer's privacy intact without profiling the consumer, while working to help the consumer and expedite the shopping process.

### Speed and Convenience

If consumers are to continue to use a new system or application, that application must enhance and build upon their prior experience. Much of the prior art burdens the customer with an extra tool or substitutes a new step in place of an old one, while making no great improvement in the consumer's sense of power over the technology or the consumable. The present invention brings consumers and retailers the same level of independence and advantage. The present invention enhances and improves the shopping experience for customers by obviating lines and checkouts, The present invention offers incremental implementation for retailers at minimal cost and maximum convenience through customer and stock tracking, so as to know what to restock when, and what customers are buying the most. In turn, this facilitates the mapping of individual stores, so as to optimize consumers' in-store shopping paths and lead retailers to offer more personalized shopping services.

The present invention works simply without confusing or over-burdening customers, instead offering them the diversionary chance to interact and learn about specific products from fellow consumers. The present invention rewards consumers for using this mobile app, and builds upon the industry trend of offering exclusive benefits for preferred customers. The present invention uses consumer profile information to better help customers track and manage their shopping lists, without profiling them, thereby maintaining the privacy customers expect from online transactions. The present invention can be implemented gradually over a course of time, instead of all at once. Instead of offering expensive new systems, the present invention offers evolutionary progress in the in-store shopping system by removing the need for lines and cashiers, drawing upon already extant mobile scanning technology. The present invention offers customers and retailers the monitoring of purchases, product information, and social shopping to enhance the overall shopping experience, while maintaining privacy and expediting the shopping process.

### BRIEF SUMMARY OF THE INVENTION

The present invention is a complete mobile shopping system for automating the checkout process, thereby improving personal and business productivity, efficiency and goal attainment, and the buying of products and goods. The mobile shopping system may include a bar-code scanning and information-accessing systems (including hardware, software, and peripherals). The present invention simplifies and democratizes the checkout process by method, apparatus, and system by drawing upon other fields, including but not limited to: barcode scanners, barcodes and other mobile and machine readable symbologies such as QR codes; inventory control; social networks; a rewards system as well as other business processes and human and business behavior as it responds to the adoption.

The present invention improves the ease, accuracy, and functionality of the hardware, software and processes for checking out and buying, as well as pre-ordering consumables, products or services related to selling an item, controlling and restocking items by notifying store managers and personnel when a stock has reached a minimum inventory level, or level otherwise determined by the store, and enhances and facilitates the shopping experience for the resulting consumables sold by a retailer and purchased by a consumer. The present invention rids retailers of the shopping line process and returns to consumers the time they would spend waiting in line, while offering important information, benefits, and analytics about specific consumables, both for retailer and consumer.

### BRIEF DESCRIPTION OF THE DRAWING

The drawings are not drawn to scale.

FIG. 1 is a block diagram of purchasing a product from a retailer with a mobile device, in accordance with the above description of the present invention.

FIG. 2A is a depiction of a screenshot of the scan confirmation.

FIG. 2B is a depiction of a screenshot of a scan screen.

FIG. 3 is a flowchart depicting the process of purchasing a product from a retailer with a mobile device in accordance with the above description of the present invention.

FIG. 4 is a graphic depiction of a social shopping system of an embodiment of the present invention.

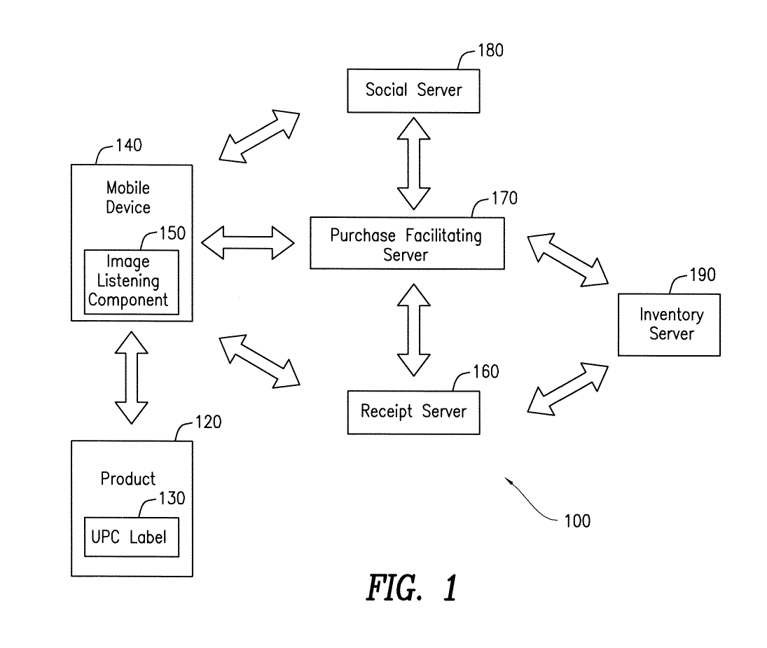

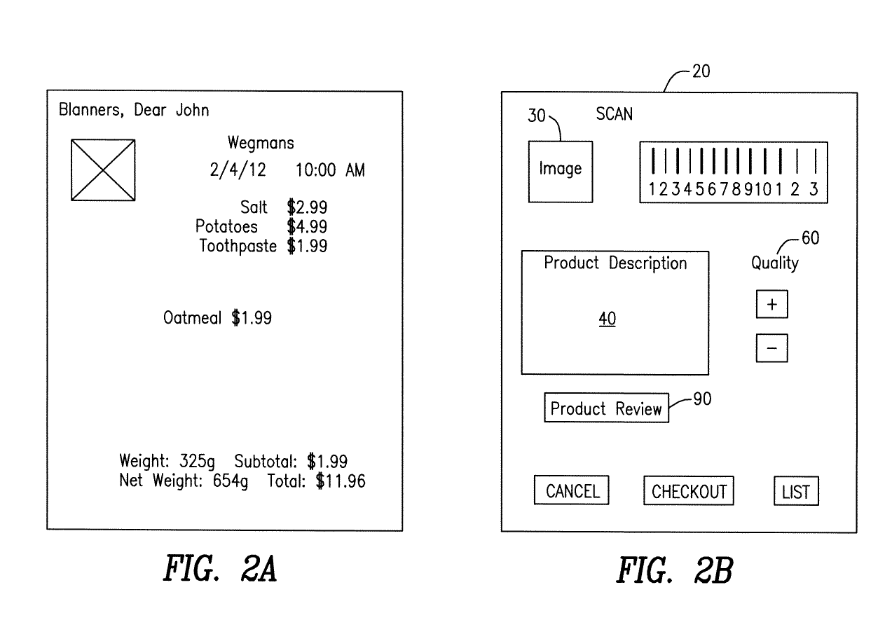

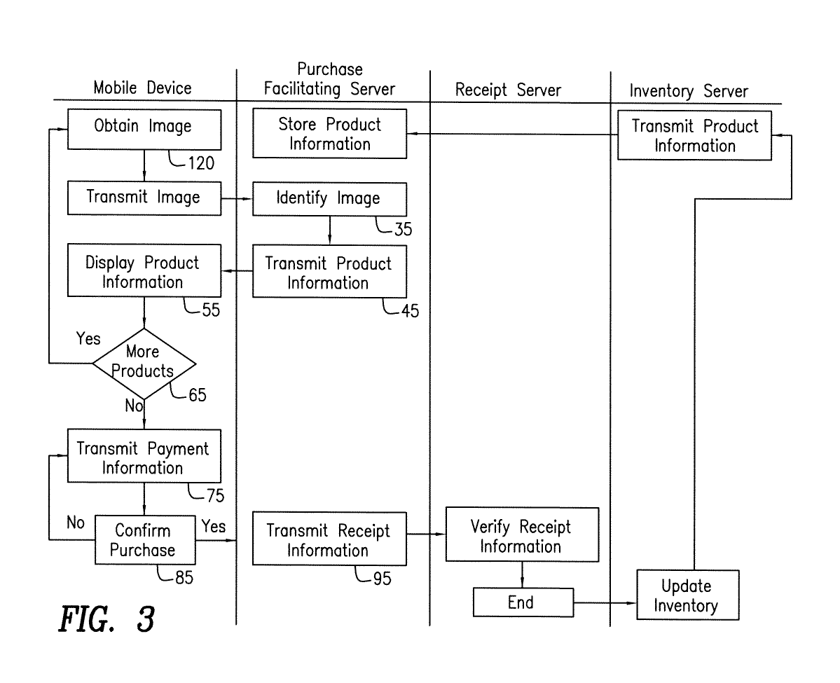

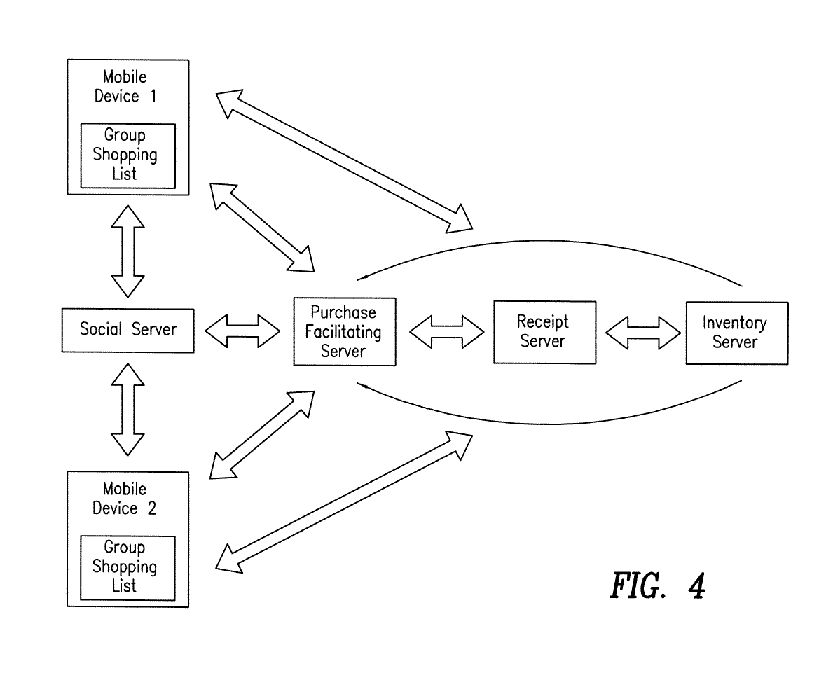

### GLOSSARY

### Bar Code Scanning Beep

The sound a cashier makes when a consumable's UPC is scanned. Cloud: A network of hardware and software systems which are delivered over the Internet, or other network. The cloud functions in three different ways: as infrastructure, platform and software services.

### Consumables

Any product or service that can be bought or sold at a retail or wholesale store. Consumers: Users of the present invention, interested in mobile shopping and the purchasing of consumables. Follow(er): To link virtually one consumer profile with another, based on the standards of other social networks, including but not limited to, receiving updates from, and the ability to view and track activity of, the other consumer profile.

### Geo-Location

Geographic location makes use of satellite technology to track a specific mobile device with regard to its location on a map or virtual grid.

### Information Bump

A sharing of information, transfer of monies or other communicative data registered through the touching or “bumping” of two or more mobile devices.

### Mobile Shopping

The process of using a mobile device for price comparisons, product reviews, and retailer information, with or without actually buying an item.

### QR Codes

Quick Response codes are readable through most mobile technology. Using scanning technology and at least one server the mobile device scanning the code may be taken to a specific website or information page.

### Profiles

Virtual medium of information, social, and photograph sharing via a remote comuter-based server, capable of linking and being followed by other profiles on a virtual map. Retailers: Stores or places of retail where consumables are sold.

### RFID Tags

Radio frequency identification, denoting technologies that use radio waves to identify microchips in objects, packages, or bags. This term also includes variants such as Near Tags, Near REID Tags, and RFID Tags.

### UPC Codes

Universal Product Code, also known as a bar code, is a machine readable code that comes in the form of letters and numbers and a pattern of parallel lines in order to identify an product.

### DETAILED DESCRIPTION OF THE INVENTION

The present invention consists of a mobile technology application that uses UPC codes, QR codes, RFID tags, an “information bump,” or Bluetooth technology to purchase consumables to create a fast, reliable mobile shopping strategy system. The present invention enhances the shopping process by geo-locating the consumer within an area and specific retailer, offering a route by which to most quickly gather consumables. The present invention provides information about retailers and products for consumers; notifies consumers of linked profiles within the retailer or nearby; integrates a simultaneous shop and payment system; offers an instant reward system; implements a weighing system to verify payment; and accounts for consumer habits and preferences in a network of user-built profiles and retailer's inventory control. The present invention can be used in different markets, including retail or wholesale stores with a wide variety of items that require periodic replacement and a cashier-checkout process.

The present invention employs a mobile scanning system that improves transactions between retailer and consumer. This invention does not require universal adoption, facilitating implementation over the course of a longer time and with the help of different technologies. Gradual implementation means the technology can be easily adopted by a variety of retailers, and it can also meet consumer's changing shopping habits, providing a segue to universal implementation for consumers and retailers. Unlike prior art, the present invention offers a more complete and widely implemented alternative than current checkout or home delivery alternatives.

For example, a customer using the present invention would scan a desired consumable's Universal Product Code to purchase the product immediately, using a credit or debit card payment method, a third-party payment holding system, or by bringing the consumable(s) to a register for retailer verification and cash payment, as a guest on the mobile application.

In accordance with the present invention, the consumer opens the present invention on a mobile device, such as a smartphone or tablet to see five options: map, search, scan, social, rewards. Using a username and password or number sequence login, the user chooses a particular retail location from nearby shopping locations through geo-location. The consumer can see himself relative to other shoppers and linked profile users of the present invention on an in-store geo-location screen. The consumer has the option of searching for a particular item in the store, following a mapped shortest route to the selected product, or if the user has a list of items, a shortest shopping route through the entire store to pick up those listed items.

If the consumer prefers not to search, he can move directly to a scan-ready screen and proceed to select a consumable and scans its UPC code to put it in a virtual checkout. The mobile device will flash red and make a beep imitative of UPC scanning devices. The scanning technology works in accordance with UPC codes, QR codes or RFID tags, registering the price of each consumable product by sending this information via data packets over the Internet to at least one remote server associated with the chosen retailer. The at least one remote server responds to the information stored by the specific retail location and the goods purchased by the user and identifies the vendor from which said goods are transmitted to the mobile device. The at least one server responds to the consumer's scanning of UPC codes, QR codes, or RFID tags and transmits the price of the selected goods to the mobile device. The process works the same way in a search for a specific product, from mobile device to retailer's remote server, on which product information such as aisle location, price and weight is stored, then responds to the information stored by the retailer and sends the information back to the consumer's mobile device. If the consumer experiences any problems, he will be able to push a “call” button to notify retail associates of his location within the store.

In case the consumer's phone were to die, he would be able to take it and checkout at the storefront where he would be recognized by name or an information bump, pay for his groceries, and resume shopping traditionally, checking out by cashier. Here a retail associate will be able to conduct the checkout process virtually on another mobile device, and then allow the consumer to finish shopping via traditional methods, i.e. without use of the present invention. The consumer's scanned items accumulate until he is finished shopping, whereby he chooses payment method, inputting credit or debit card payment information to be processed directly or through a virtual payment system such as Paypal or Payoneer. Cash payments may be made at the front of the store if the user is a guest, without a login or username. Different checkout methods, such as human confirmation of physical list with virtual list; an information bump of list from consumer to retailer; the weighing of consumables' net weight and comparing it to net weight of listed consumables on a receipt, are slowly implementable for retailers' convenience.

The at least one server may store information including but not limited to, the user's history of which items have been bought from a specific shopping location, user reviews for each and every product, a product's specific location within a specific retail store, the weight of the item, the price of the item, how many items are left until depletion, products bought most often, aisles visited most frequently, etc. The consumer's shopping history, product preferences, receipt totals, user reviews, etc., may be saved on said consumer's specific account or in a particular profile and linked to profiles on separate mobile devices in order to monitor shopping histories on friends' or family members' mobile devices. This would facilitate in product reclamation and food alerts should harmful or poisonous foods arise. In such a case, linked profiles can be circumscribed within authority of a primary payment holder, which, in the case of families can be used to set monetary limits and age restrictions. The user's shopping history can also be used to itemize and bookmark selected routinely bought items, as well as search for and categorize previous shopping lists according to preferences, i.e. brands, highest rated, most purchased, etc.

The consumer's physical location may be displayed on a virtual map with relation to other nearby retailers who use the present invention. Consumers will be able to send alerts to retail associates when in need of help, and with the aid of GPS technology, will be located easily. The map may display available consumables relative to the selected shopping location as well as the user's path through the selected shopping location according to a grid system. A specific consumable may be located in aisle B and shelf space 11. For pre-saved shopping lists, the present invention will offer time-saving methods for shopping, including the fastest route by which to move from one consumable to the next, and will take into account the ambient temperature of certain aisles so as to preserve temperature-sensitive products.

According to this method the retailer's stocking and item replacement system can be better monitored by the present invention, communicating through the retailer's server which items have been bought in a specific location. The at least one server can store information relating to purchased consumables. The stored information may include consumables purchased by the user, as well as the consumables currently within the store, on the shelf, relative to the maximum number of consumables that can be stored on the shelf. When the number of consumables reaches a level below the retailer's set preferences (based on numerical standards, weekly challenges, associate responsibilities, etc.), the retailer may receive a notification that the specific items have fallen below the retailer's set preferences, and are now ready for restocking or analysis, thus ensuring rapid and accurate retail restocking, as well as streamlined store management.

Furthermore, retailers can obtain accurate analytics regarding the purchasing of consumables, trackable by time, product or location. These statistics will include location based information about consumers in the form of statistics, charts, and conversion rates, i.e., how much each consumer is spending on which products or what percentage a specific product constitutes of their total list, and breakdowns of consumers. Moreover, retailers can make notes on consumers who have difficulty, handicaps, or other issues, as well as target specific retailers with specific promotions.

The geo-location method also allows consumers to call staff members from their present GPS location, sending a help-beacon to an associate notifying him that a nearby consumer has a question or needs assistance. Improved customer service would follow, so that staff will be able to help customers find specific consumables, prevent theft, and aid in any other circumstance.

Consumers will have a profile page on which to load photographs, information and other pertinent resources. From their profile they have the option to move from shopping to social to map functions of the present invention. The map function shows the consumer's physical location within the retailer, and offers search capabilities, for consumers to find products and friends relative to him. The shop function allows consumers to scan the UPC code of a specific consumable, as well as notify linked profiles via home profile of a special deal or review, in, or out-of-network. The social function, in turn, will list recent deals friends are shopping for, as well as user reviews, photographs and other relevant information. Users can follow other user profiles based on the standards of pre-existing social networks, e-mail addresses, or the profiles of users only on the present invention. Consumers will also be able to notify friends of their purchases and plan lists together for special occasions. The underlying social network of the present invention buoys the shopping strategy and provides entertainment for consumers.

As a security measure, consumables will be weighed and matched with consumers' receipts. Since the net weight of an individual product will be entered into the retailer's server in accordance with the stocking criteria of that consumable, a net weight of total consumables according to the consumer's receipt will be matched with the physical net weight of the user's inhand consumables. The confirmation of physical net weight of consumables matching with virtual net weight of consumables according to a consumer's receipt will be carried out by authorized retailer associates. At first, this process will be randomized, becoming less frequent as the system is implemented over a wider range of retailers and consumers, thus providing a standardized expectation that any form of theft within the present invention is intolerable and that the system itself is inviolate.

For loose items not individually packaged, including but not limited to, items such as fruits, vegetables, nuts, grains, etc., the consumer places these loose items in plastic bags on a local weighing system linked to each user's account through a reader list system. This reader list system is synced with a barcode system for that consumer's gross loose items, which sends information to the retailer's server and adds the weight and price to the user's virtual receipt.

The consumer may also identify a vendor or specific items as preferred after having bought that item from that specific vendor in the past; the mobile device thereby provides the consumer with a list of past purchases and allows the consumer to revisit a specific vendor to obtain goods or services bought before, potentially building a mobile shopping list specific to an individual vendor. This would constitute at least one aspect of a profile for the consumer. The consumer would also have the ability to store different lists according to different vendors. The consumer would also have the option of reviewing every item in the store, which would create a forum for consumers to discuss each consumable. The consumer would also have the option of linking profiles under one account and following other users to monitor their profiles and preferences, as heretofore discussed, based on the invitation standards of “friending” or “following” in other social networking systems.

A cash-back reward system based on how much consumers spend at a specific store will be implemented, so that consumers can choose to get money back through a third-party system such as Paypal or Payoneer, a direct cash refund through a bank account. or a mailed check. Preferred customers who spend a certain amount of money weekly or monthly will receive exclusive offers. These offers will work in a qualifying system, so that those who qualify as most exclusive will have options such as a personal shopper, or better parking. Dollars spent translate into points, so that the more points earned, the closer one is to cash-back rewards, based on trade secrets. Of course, this reward system may be implemented gradually so as to build a loyal consumer base before exercising the option of how to best reward those consumers spending the most money with the present invention.

The mobile application will implement a username/password login combination for consistent users. This selected profile can store previous chosen consumables; receipts; rewards earned or required amount of spending until more rewards are earned; credit/debit card information; and past retail locations in which the user has shopped. Guest users, or users who prefer not to save a profile with the aforesaid information have the ability to pay with cash at the retailer's checkout.

The consumer has the option of keeping a virtual receipt, which may be e-mailed to the consumer's direct address, or the consumer may choose a physical print out of the receipt, or the option of both e-mailed and physical receipt print out. On this receipt will be information regarding the specific mobile phone from which the consumer's consumables were purchased, serving as further verification and acting in accordance with security measures.

A system facilitating improved mobile shopping technology in accordance with the present invention requires a retail location with a plurality of consumable goods; a bar code available for each and every consumable item, including but not limited to, loose or nonpackaged consumables such as fruits, vegetables, grains, nuts, candy, coffee, breads, etc.; more than one server which receives data containing the goods desired to be purchased from the mobile device by a user; a mobile payment system which utilizes credit and/or debit card information to confer the transaction; a random human-imposed verification and weighing system to deter shoplifters by confirming that the contents of a user's virtual receipt correlate to the physical contents in a user's bag; and the mobile application which provides to the consumer a list of previously purchased and presently available goods and consumables which serves as a function of at least one of the consumer's profiles.

In one embodiment the invention discloses a system and method for consumers to enter a store (physical or online) and have access to a comprehensive mobile shopping system. The system includes but is not limited to a search and scan checkout; a verification and theft prevention weighing procedure; a retailer-consumer and consumer-consumer geo-locating and tracking map; a social shopping network using consumer mobile shopping profiles, as well as a rewards system.

In another embodiment the system and method of the present invention allows consumers to place an order from product inventory, using bar code scanning technology from a mobile device. The invention thus includes obtaining information about a consumable; choosing said consumable by scanning a bar code; the scanning of the UPC done by taking a temporary image of the UPC via an image reading component of the mobile device; sending the image to the mobile device; offering the consumer the option to continue with the process and purchase the product; processing the consumer's choice to continue with the payment process; and sending the payment information to the retailer; deleting the image of the UPC; and transmitting to the mobile device a confirmation of the purchase of the chosen consumable; the purchasing of loose consumables done by weighing and printing out scannable bar codes with the specific weight of those specific loose consumables.

The invention may also list chosen and purchased, or yet-to-be purchased products, in a display of price, weight, and product name. It permits scanning each specific code and storing it in mobile device's memory until the next code is scanned or the user chooses to send payment information to the retailer. The invention may also send each specific code to at least one server owned and operated by the retailer. The invention may also identify each specific code with its corresponding product and add each corresponding product to the list of products chosen. Loose items can be added to a customer's list of product's net weight by adding the weight of any aforementioned specific loose item(s). Likewise price of the specific loose item can be added to the customer's list of products.

The invention may also include a computer-readable storage medium with a plurality of computer-instructions that, when within at least one server, transacts a purchase of a specific item or set of items from a retailer. The invention includes receiving from a mobile device the image of a UPC taken by the user with the mobile device; accessing information from the retailer about the price and consumable chosen by the consumer: accessing information including but not limited to the consumer's credit/debit card payment information; sending to the mobile device a confirmation of the payment and purchase of a chosen product. The invention may permit purchasing each chosen product by adding the prices of scanned items in order to provide a subtotal for the user as each item is scanned and allowing a credit or debit card payment system to tally and/or remove a specific item from a user's profile. New users may forgo a credit or debit card payment system in order to pay by cash at the checkout counter and the invention may offer home delivery should the user so choose. Finally, the retailer's may be given the ability to see what a consumer has prepared to purchase already on the retailer's mobile device.

In another embodiment of the invention there is a theft prevention and in-store security system. The system includes authorizing identification of user's products with products on the user's receipt based on a visual indicator offering agreement with or rejection of terms and conditions, the scanning into an interface of a receipt of bought items and the weighing of the items the consumer has already bought in order to verify that the weight of the collected and purchased consumables should match the net weight of the purchased consumables as listed on the virtual or physical receipt. This model also allows consumers the ability to buy consumables online and pick up in-store, shop in-store with the option of home delivery, and begin shopping with a mobile device, and should the device fail to work or run out of batteries, be able to pay via a virtual receipt on another mobile device, then resume shopping traditionally. An added feature of the theft prevention and in-store security system is where the net weight of each specific item is registered within a computer based storage medium. Another way to implement the theft prevention and in-store security system is to randomize matching of virtual receipts with physical items' weight so an in-store employee or associate can monitor user's while shopping. The theft prevention and in-store security system may also include the retailer storing in at least one server and computer-based storage medium of a single consumer's purchase confirmation, product identification, and possible mismatching of one physical or virtual receipt with physical weight of net consumables, as part of a user's profile history.

A system is also described comprising: at least one server to transfer and store user login information to create a profile for a specific consumer, wherein said profile may store and save purchase and payment information; dietary preferences; previously chosen products; most often chosen products and consumers favorite brands; specific shopping lists with consumables, dates, weights, and prices; and consumer reviews for each and every consumable. The system may also include:

1. the ability to review and rate a specific consumable, as well as the ability to post a photograph, recipe, or act as another source of information for other profiles,

2. the generation, linking and management of multiple consumer profiles within one account, according to the primary credit or debit card holder within that account

3. enabling monetary, age and dietary restrictions for a specific user profile within an account by the primary account holder; or in other words, the profile from which payment information is specified,

4. visiting and following other consumer profiles, via in-store geo-location as well as out-of-store servers, outside a specific account to share reviews, photos of consumables, and recommendations regarding consumables and specific items, and

5. rewarding cash back via a third-party cash holding system, mailed check or debit refund to a bank account at a pre-determined percentage to a specific profile or account after a pre-determined level of spending has been reached by the user of the profile or account. The method also including exclusive offers for preferred customers based on amount totals spent over a given period of time, and translating the dollar amounts into points, levels of rewards, and incentives.

In another embodiment there is at least one server and computer-based storage medium over which computer-executable instructions can be read, which allow a mobile device to perform a shopping method comprising: bar code scanning technology, comprising: obtaining information about a product for sale offered by a retailer and chosen by the consumer; choosing said product by scanning a UPC; the scanning of the UPC done by taking a temporary image of the UPC via an image reading component of the mobile device; sending the image and product net weight to the retailer; offering the consumer the option to continue with the process and purchase the product; processing the user's choice to continue with the payment process; and sending the payment information to the retailer; deleting the image of the UPC; transmitting to the mobile device a confirmation of the purchase of the chosen consumable and the storing a list of selected products desired for purchase by the consumer.

The invention may also include: storing each consumer's shopping list in the retailer's at least one server and computer-based storage medium; and sending to the consumer a confirmation of the list of consumables chosen for purchase and supplementing confirmation with an e-mail of the consumer's list and receipt to the consumer; as well as a method for retailers to track and monitor individual stock of a specific item on at least one server and computer-based storage medium comprising: storing lists of each scan-able item; registering each item in a stock, and saving lists of every time a stock has been in any way diminished or replenished; the weight of each consumable product; the location of each consumable product within the store and within each aisle.

The invention may further include identifying and alerting retailers of when stock has dropped below a certain level set and defined by a retailer. Additionally, this claim allows consumers a “rain-check” on a specific consumable when it is out-of-stock, specifically when on sale, the consumer then will be able to buy the consumable at a later date, for that sale price. The at least one server and computer-based storage medium may further include sharing a shopping list with another consumer, based on invitation. The invention may still further include:

1) ways for retailers to track and monitor consumer's shopping progress using geolocation of the user with relation to a physical map of the retailer; as well as for consumers to track and monitor consumer profiles of those they are following, both in and out-of store,

2) options of sharing nearby deals and reviews of a product, with profiles the consumer is following, both in and out-of-network,

3) geo-locating the consumer with relation to other retailers registered with the present invention within the nearby area,

4) importing e-mail addresses and connecting to other social networks whereby the consumer may add and import friends into a profile, so as to then track and follow those consumer profiles,

5) geo-locating the consumer within specific retailers; and tracing the user's path within a store,

6) saving data in a computer-based storage medium to allow retailers to determine where users spend the most time within a specific retail location, the paths they trace within a specific location, how much of and when they buy a specific consumable, as well as other pertinent retailer-managerial data and resources,

7) mapping of each consumable within a specific retailer, with relation to aisle and shelf space, broken into a gridded system of letters and numbers, as well as the consumer's physical relation to each chosen consumable,

8) mapping of a user's route through a specific store according to their pre-chosen items on a shopping list of consumables, and

9) locating of a specific consumer according to that consumer's alerting nearby retail associates with a homing beacon, radio waves, or other yet-to-be specified technique, acting as a “call button” to facilitate improved customer service.

While the present invention has been described in conjunction with specific embodiments, those of normal skill in the art will appreciate the modifications and variations can be made without departing from the scope and the spirit of the present invention. Such modifications and variations are envisioned to be within the scope of the appended claims.

1. A mobile shopping system comprising:
a processor; and
a memory comprising program instructions that are executable by the processor to implement a mobile shopping service wherein a consumer can choose a product from product inventory;
place an order from said product inventory;
purchase the chosen product;
provide payment information to a retailer; and
obtain confirmation of payment for the chosen product.

2. The system of claim 1, wherein the payment information is obtained by accessing a mobile shopping account associated with the consumer.

3. The system of claim 1, wherein the chosen product is identified by scanning a UPC.

4. The system of claim 1, wherein the chosen product is identified by selecting a product displayed on said product inventory, said product inventory being online.

5. The system of claim 1, further comprising access retailer price information for he chosen product.

6. The system of claim 1, further comprising access to said consumer's payment information including but not limited to credit and debit information.

7. The system of claim 1, further comprising access to weight information for said chosen product, wherein said weight information is included in completing a purchase transaction.

8. The system of claim 7, further comprising a weight record, said weight record being a theft deterrent when said weight record for said chosen product does not match weight of the chosen product at checkout.
